(19) United States
(12) Patent Application Publication
(10) Pub. No.: US 2005/0100390 A1
(43) Pub. Date: May 12, 2005

(54) Paint dispensing system and apparatus

(76) Inventor: Juanita Jantz, Marana, AZ (US)

Correspondence Address: Steven Thrasher, 391 Sandhill Dr., Richardson, TX, 75080, US

(21) Appl. No.: 10/705,168

(22) Filed: Nov. 7, 2003

(51) Int. Cl. B43K 5/06

(52) U.S. Cl. 401/179; 401/176

(57) ABSTRACT

The invention is a paint dispensing system and apparatus for eliminating the inconvenience of locating and readying necessary paint and painting tools for small painting projects. In a preferably embodiment, the paint dispensing system provides a means for a paint dispensing apparatus to be easily held and interchanged with other paint dispensing apparatuses. The paint dispensing apparatus is a syringe adapted to preserve and dispense paint. In addition, the syringe tip portion is adapted to removably attach a paint tool assembly to aid in the manipulation of dispensed paint.

### TECHNICAL FIELD

The invention relates to painting, and, more particularly, the invention relates to painting tools.

### STATEMENT OF A PROBLEM ADDRESSED BY THIS INVENTION

Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Statement of a Problem Addressed by This Invention is to be construed as prior art

Discussion

For some, painting is an occupation and for others, it is recreational activity. However, for all painters, the task at hand may not be accomplished without the appropriate paint or painting tools. Large painting projects such as painting a house, for example, may require paint rollers, large brushes, and large portions of paint. Small painting projects such as touch up projects or art projects, for example, may only require one fine brush and a small dab of paint.

Unfortunately, smaller painting projects may be avoided due to the inconvenience of locating and readying the necessary paint and painting tools to complete the task. Gathering and readying the supplies for the task at hand may take a considerable amount of more time in comparison to the time needed to complete the task. Furthermore, purchasing the necessary painting supplies for the small task may be costly and an inconvenience in itself.

### SELECTED OVER VIEW OF SELECTED EMBODIMENTS

This invention provides technical advantages as a paint dispensing system and apparatus that eliminates the inconvenience of locating and readying necessary paint and painting tools for small painting projects. Preferably, the paint dispensing system comprises a paint dispensing apparatus and at least one paint dispensing apparatus holder. The paint dispensing apparatus is a syringe adapted to preserve and dispense paint. In addition, the syringe tip portion is adapted to removably attach a paint tool assembly, such as a brush or hose for example, to aid in the manipulation of dispensed paint. Furthermore, the paint tool assembly may include a paint plug to seal and preserve paint within the syringe barrel.

The paint dispensing apparatus comprises a syringe barrel having a hollow chamber enabled to receive a plunger, and also having a tip adapted to removably attach to a paint tool assembly. Furthermore, the paint tool assembly comprises a mounting portion, a tool portion, and a hollow passage adapted to couple the mounting portion to the tool portion. The mounting portion is adapted to removably attach to the tip of the syringe. The tool portion is enabled to couple to a painting tool, such as a brush, hose, or paint plug, for example. The hollow passage that couples the mounting portion to the tool portion enables paint to flow from the mounting portion to the tool portion and ultimately through the painting tool to the desired surface.

The paint dispensing apparatus holder comprises a pipe having a cavity and a fastening means coupled to the pipe via an arm. In a preferred embodiment, the fastening means secures more than one panting dispensing apparatus holder such that each pipe rotates around the central axis of the fastening means. Furthermore, the fastening means is screw that is removably attachable from the arm.

Of course, other features and embodiments of the invention will be apparent to those of ordinary skill in the art. After reading the specification, and the detailed description of the exemplary embodiment, these persons will recognize that similar results can be achieved in not dissimilar ways. Accordingly, the detailed description is provided as an example of the best mode of the invention, and it should be understood that the invention is not limited by the detailed description. Accordingly, the invention should be read as being limited only by the claims.

### BRIEF DESCRIPTION OF THE DRAWINGS

Various aspects of the invention, as well as at least one embodiment, are better understood by reference to the following EXEMPLARY EMBODIMENT OF A BEST MODE. To better understand the invention, the EXEMPLARY EMBODIMENT OF A BEST MODE should be read in conjunction with the drawings in which:

FIG. 1 illustrates a paint dispensing apparatus;

FIG. 2 illustrates a cross section of a paint dispensing apparatus.

FIG. 3 illustrates a paint tool assembly.

FIG. 4 illustrates a perspective view of one embodiment of a paint tool assembly.

FIG. 5 illustrates a cross section of a preferred embodiment of a paint tool assembly.

FIG. 6 illustrates a perspective view of a paint dispensing apparatus holder.

FIG. 7 illustrates a top view of a paint dispensing apparatus holder.

FIG. 8 illustrates a cross section of a paint dispensing apparatus holder.

### AN EXEMPLARY EMBODIMENT OF A BEST MODE

Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”). Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for—functioning—” or “step for—functioning—” in the Claims section.

Discussion of the Figures

The invention can be characterized as a paint dispensing system and apparatus that eliminates the inconvenience of locating and readying necessary paint and painting tools for small painting projects. In a preferred embodiment, the paint dispensing system is a paint dispensing apparatus holder combined with a paint dispensing apparatus. The paint dispensing apparatus is a syringe that is adapted to preserve and dispense paint. Furthermore, the syringe tip is adapted to removably attach a paint tool assembly.

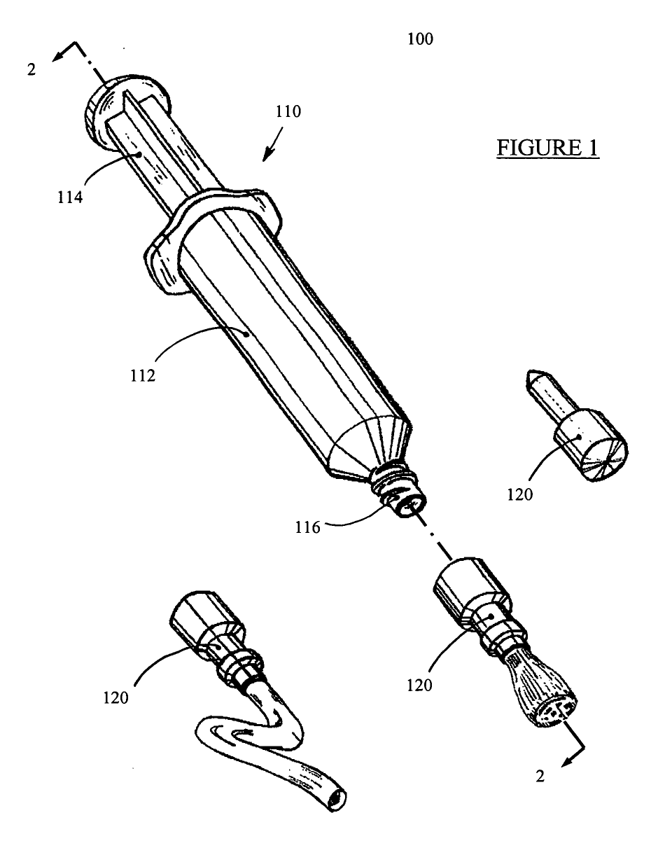

Features and advantages of the invention can be better understood by reviewing FIG. 1, which illustrates a paint dispensing apparatus 100 adapted to preserve and dispense paint, thereby eliminating the inconvenience of locating and readying paint and painting tools for small painting projects. The paint dispensing apparatus 100 comprises a syringe 110, having a barrel 112 enabled to receive a plunger 114, and also having a tip 116. Furthermore, the tip 116 is adapted such that a paint tool assembly 120 may removably attach.

The syringe 110 is similar in shape and size to syringes used for medical applications and may be made of plastic or other materials generally known to those skilled in the art. The barrel 112 comprises a hollow chamber that is generally cylindrical. The barrel 112 is enabled to store and dispense fluids, such as paint, for example. In addition, at the most proximal end of the barrel 112 a mouth is enabled to receive a plunger 114. Furthermore, the tip 116 is located at the distal most portion of the barrel 112. In a preferred embodiment, paint may be stored within the syringe 110 and dispensed through the tip 116 to the paint tool assembly 120 by pressing the plunger 114.

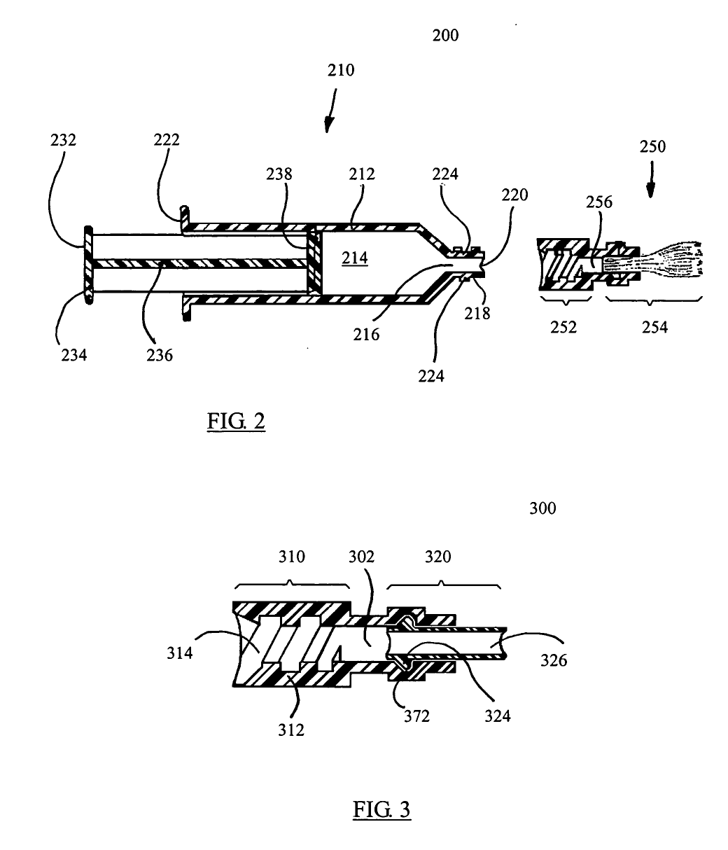

FIG. 2 illustrates a cross section of a paint dispensing apparatus 200. In a preferred embodiment, the paint dispensing apparatus may have a removably attached paint tool assembly 250. In an alternative embodiment, the paint dispensing apparatus 200 may have a paint tool assembly 250 that is integrally formed within a syringe 210.

The paint dispensing apparatus 200 comprises a syringe 210 and a paint tool assembly 250. The syringe 210 comprises a barrel 212 having a hollow chamber 214, a passage 216, a tip 218, an orifice 220, a proximal finger grip flange 222, and an external array of threads 224. The syringe 210 provides at least the advantage of proving a user a means to force paint into a dispenser or brush without relying on (or fighting) gravity.

The hollow passage 216 is coupled to the chamber 214 thereby forming a continuous pathway passing through the tip 218 and terminating at the orifice 220. Paint stored within the chamber 214 travels through the pathway whereby it exits the orifice 220. The orifice 220 is the most distal portion of the tip 218.

The external array of threads 224 may be integrally formed on the exterior surface of the tip 218. In one embodiment, the external array of threads 224 may be any number of raised evenly spaced angled threads on the surface of the tip 218. In an alternative embodiment, the external array of threads 224 may be at least one concentric thread.

The barrel 212 is enabled to receive a plunger 232 having a proximal thumb flange 234, a plurality of vanes 236, and a distal disc 238. The proximal thumb flange 234 enables the plunger 232 to be pressed with one's thumb. The plurality of vanes 236 may be integrally formed within the plunger 232 and extend parallel from the proximal thumb flange 234 to the distal disc 238. The distal disc 238 is a generally cylindrical and creates a seal within the chamber 214. In a preferred embodiment, the distal disc 238 is rubber, for example. In alternative embodiments, the distal disc 238 may comprise other materials creating a seal, as know to those skilled in the art.

The paint tool assembly 250 comprises a mounting portion 252 and a tool portion 254. The mounting portion 252 is coupled to the tool portion 254 via a passage 256. The mounting portion 252 is adapted to removably attach to the external array of threads 224. The passage 256 is generally circular in cross section. The tool portion 254 is enabled to secure a paint tool to the distal end of the paint tool assembly 250. In a preferred embodiment, paint may pass from the orifice 220 thru the passage 256 to the tool portion 254, whereby the paint is dispensed to a surface. In an alternative embodiment, paint may pass from the orifice 220 thru the mounting portion 252, to the passage 254, and finally to the tool portion 254 whereby the paint is dispensed to a surface.

FIG. 3 illustrates a paint tool assembly 300 having a mounting portion 310 coupled to a tool portion 320 via a passage 302. In a preferred embodiment, the mounting portion 310 comprises a collar 312 having an internal array of threads 314 adapted to removably attach to an external array of threads on the surface of a syringe tip. The mounting portion 310 is generally circular in cross section and may screw to the syringe tip. In an alternative embodiment, the collar 312 may removably attach to a syringe tip via at lease one concentric thread, a notch, or other means known to those skilled in the art.

In addition, the tool portion 320 comprises a notch 322, a securing means 324, and a painting tool 326. The securing means 324 is integrally formed within a proximal portion of the painting tool 326 such a brush, hose, rod, or plug, for example. In a preferred embodiment, at least one painting tool 326 is adapted to attach to the tool portion 320. In an alternative embodiment, more than one painting tool 326 may be adapted to attach to the tool portion 320.

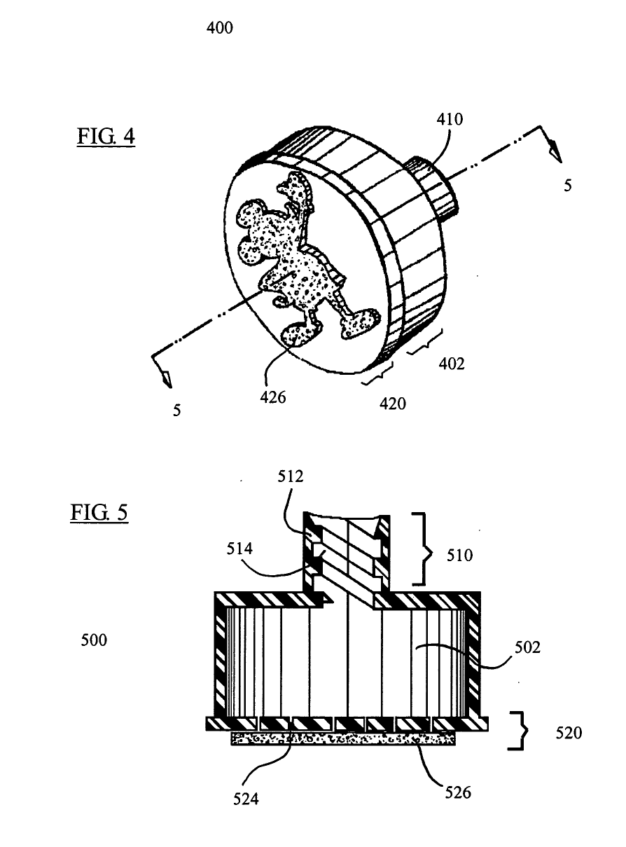

FIG. 4 illustrates a perspective view of one embodiment of a paint tool assembly 400 having a mounting portion 410 coupled to a tool portion 420 via a passage 402. Preferably, the tool portion 420 comprises a sponge 426 that generally represents the silhouette of a cartoon character, such as Mickey Mouse™, Barney™, Pokeman™, or Bugs Bunny™, for example. Alternatively, the sponge 426 may generally represent geometric shapes or objects, such as squares, flowers, angels, or animals, for example.

In one embodiment, the passage 402 height is greater than height of the mounting portion 410 and the tool portion 320 combined and the diameter of the mounting portion 410 and tool portion 320 combined is 6 inches. Furthermore, the passage 402 is generally circular in cross section and provides a pathway for paint to travel from the mounting portion 410 to the tool portion 420 to a surface. It is apparent to those skilled in the art, that the passage 402 may be embodied in alternative shapes and diameters such that it enables paint to travel from the mounting portion 410 to the tool portion 420 to a surface.

FIG. 5 illustrates a cross section of a preferred embodiment of a paint tool assembly 500. As previously described, the paint tool assembly 500 comprises a mounting portion 510 coupled to a tool portion 520 via a passage 502. The mounting portion 510 comprises a collar 512 having an internally array of threads enabled 514 to removably attached to the tip 116 of a paint dispensing apparatus 100. Furthermore, the tool portion 520 is coupled to the mounting portion 510 via a passage 502 and comprises at least one orifice 524 and a sponge 526.

In a preferred embodiment, the tool portion 520 comprises an equidistant row of orifices 524 enabling paint to be evenly transferred from the passage 502 to the sponge 526. In addition, the sponge 526 is integrally formed within the tool portion 520. Others skilled in the art of paint may recognize that an orifice 524 may be generally circular in cross section, generally line-like in cross section, or generally represent geometric shapes for example. It is also apparent, that a sponge 526 may be removably attached via adhesive, such that it may be disposed of and replaced if it becomes dried out or torn, for example.

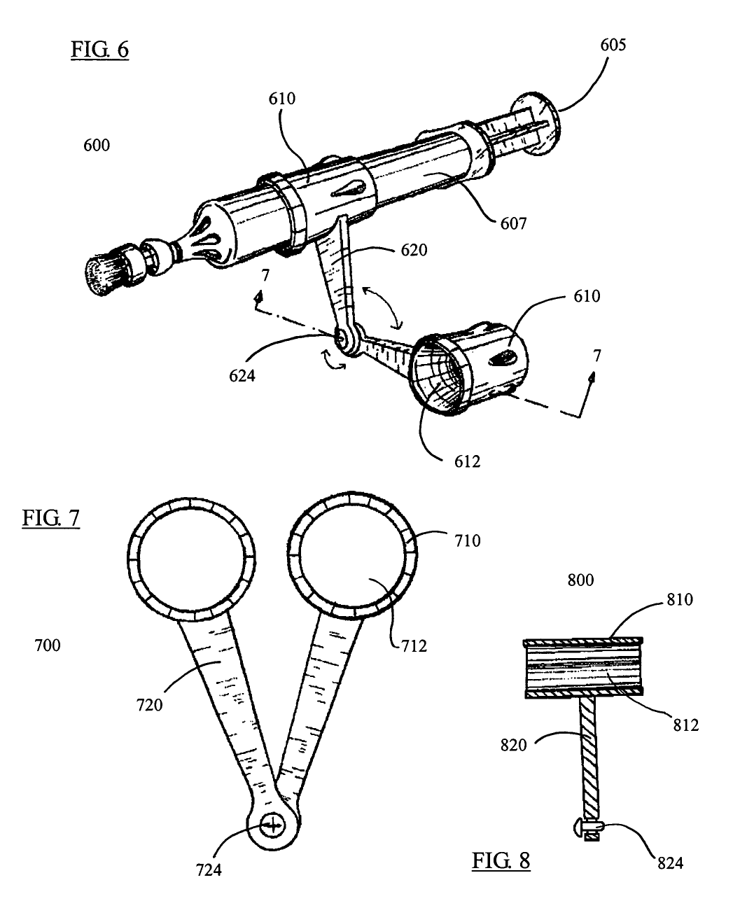

FIG. 6 illustrates a perspective view of a paint dispensing apparatus holder 600 comprising a pipe 610 and a fastening means 624 coupled to the exterior most portion of the pipe 610 via an arm 620. In a preferred embodiment, the pipe 610 is generally circular in cross section and has a generally hollow cavity 612 that is enabled to receive and hold a paint dispensing apparatus 605. Preferably, the cavity 612 diameter is slightly greater than the diameter of the paint dispensing apparatus 605 barrel 607 such that when the barrel 607 is received the barrel is retained within the cavity 612 when the paint dispensing apparatus 605 is in use. It is apparent to those skilled in the art, that protrusions may be integrally formed within the cavity that aligns with grooves integrally formed within the barrel 607 surface. Furthermore, it is also apparent that at least one protrusion within the cavity may removably interlock with at least one groove integrally formed within the barrel 607.

In one embodiment, the fastening means 624 is a nut and bolt marriage that enables at least one pipe 610 to rotate 360 degrees around its central axis. In a preferred embodiment, the fastening means is a pin that is removably attached and enables 8 arms 620 to rotate 360 degrees around its central axis. In an alternative embodiment, the fastening means 624 may be integrally formed within a least one arm 620 and the additional 7 arms 620 may snap, clip, or slide onto, a portion of the fastening means 624. It is apparent to those skilled in the art, that the fastening means 624 may have a rod attached to it central axis to act as a leg when painting on a flat surface, similarly used as a compass is to draw a circular line around a central point.

FIG. 7 illustrates a top view of a paint dispensing apparatus holder 700. In a preferred embodiment, each arm 720 coupling the fastening means to the pipe 712 is the same length. In an alternative embodiment, each arm 720 may be different lengths, such as 2 inches, 4 inches, and 6 inches, for example. It is apparent to those skilled in the art that less interference is less likely to occur if with another pipe 710 when each arm 720 varies in length.

FIG. 8 illustrates a cross section of a paint dispensing apparatus holder 800. In a preferred embodiment, each pipe 810 and its corresponding cavity 812 is identical in size in shape, such that each cavity 812 may receive and hold the same sized and shaped paint dispensing apparatus. In an alternative embodiment, each pipe 810 and its corresponding cavity 812 may vary in size, such that each cavity 812 receives and holds a different sized paint dispensing apparatus. It is apparent to those in the skill of the art that having different sized paint dispensing apparatuses may achieve benefits in practice.

Thus, though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

1. A paint tool system, the system comprising:
a syringe barrel comprising a hollow chamber enabled to receive a plunger and a tip having an external array of threads;
at least one paint dispensing apparatus holder comprising a pipe coupled to a fastening means via an arm, the pipe having a cavity enabled to receive and hold the syringe barrel; and
a paint tool assembly having a mounting portion adapted to attach to the external array of threads on the tip of the syringe barrel.

2. The paint tool system of claim 1 whereby the mounting portion comprises a collar for the securing the mounting portion to the tip.

3. The paint tool system of claim 2 wherein the collar comprises an internal array of threads.

4. The paint tool system of claim 2 wherein the collar comprises at least one concentric thread.

5. The paint tool system of claim 2 wherein the collar comprises at least one notch.

6. The paint tool system of claim 1 whereby the paint tool assembly comprises at least painting tool.

7. The paint tool system of claim 1 wherein the paint tool assembly comprises a paint brush.

8. The paint tool system of claim 1 wherein the paint tool assembly comprises a hose.

9. The paint tool system of claim 1 wherein the paint tool assembly comprises a plug.

10. The paint tool system of claim 1 wherein the paint tool assembly comprises a sponge.

11. The paint tool system of claim 1 whereby the paint tool assembly comprises a passage that couples the mounting portion to the tool portion enabling paint to travel from the syringe tip to the mounting portion, through the passage, and exit out of the tool portion via at least one orifice.

12. A paint tool system, the system comprising:
a syringe barrel comprising a hollow chamber enabled to receive a plunger and a tip having an external array of threads;
at least one paint dispensing apparatus holder comprising a pipe coupled to a fastening means via an arm, the pipe having a cavity enabled to receive and hold the syringe barrel; and
a paint tool assembly having a mounting portion comprising a collar having an internal array of threads adapted to attach to the external array of threads on the tip, the paint tool assembly comprising a tool portion having a sponge coupled to the mounting portion via a passage.

13. The paint tool system of claim 12 whereby the sponge is integrally formed within the tool portion.

14. The paint tool system of claim 12 whereby the sponge is removably attached to the tool portion via adhesive.

15. The paint tool system of claim 12 whereby the sponge is generally shaped like the silhouette of a cartoon character.

16. A paint tool assembly for use with a syringe barrel having a hollow chamber enabled to receive a plunger and a tip, the paint tool assembly comprising:
a mounting portion having a collar for securing the paint tool assembly to the tip; and
a tool portion having a painting tool; and
a generally hollow passage adapted to couple the mounting portion to the tool portion.

17. The paint tool assembly of claim 16 whereby the painting tool is adapted to removably attach to the paint tool assembly.

18. The paint tool assembly of claim 16 whereby the paint tool is integrally formed within the paint tool assembly.

19. The paint tool assembly of claim 11 whereby the mounting portion is generally circular in cross section.

20. The paint tool assembly of claim 11 whereby the passage is generally circular in cross section and used to transfer paint between the collar and the painting tool.

21. A paint tool assembly having a syringe barrel comprising a hollow chamber enabled to receive a plunger and a tip having an external array of threads, the paint tool assembly comprising:
a mounting portion comprising a collar having an internal array of threads adapted to screw to the external array of threads on the tip;
a tool portion comprising painting tool having a securing means; and
a generally hollow passage having a notch, the passage adapted to couple the mounting portion to the tool portion, and the notch enabled to secure the painting tool to the passage via the securing means.
